(19) United States
(12) Patent Application Publication
(10) Pub. No.: US 2006/0009288 A1
(43) Pub. Date: Jan. 12, 2006

(54) Conveying information to an interrogator using resonant and parasitic radio frequency circuits

(76) Inventors: John A. deVos, Corvallis, OR (US); Peter J. Fricke, Corvallis, OR (US); Gregory J. May, Corvallis, OR (US); Andrew L. Van Brocklin, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/887,055

(22) Filed: Jul. 7, 2004

(51) Int. Cl. A63F 13/00

(52) U.S. Cl. 463/39

(57) ABSTRACT

A method of conveying information to an interrogator includes the interrogator sensing the presence of a resonant radio frequency circuit that is tuned to a first resonant frequency. Responsive to a parasitic radio frequency circuit being brought to within a parasitic coupling distance of the resonant radio frequency circuit, the interrogator senses a shift in the resonant frequency of the resonant radio frequency circuit, wherein the shift in the resonant frequency conveys information to the interrogator

### BACKGROUND

Radio frequency identification circuits are used in many applications where information is to be communicated over a short distance without requiring the reader (or interrogator) to be in physical contact with the radio frequency identification circuit. The use of radio frequency identification circuits is generally preferable over conventional optical bar codes since the identification circuit need not be visible to the interrogator. Further, radio frequency identification circuits can be hidden in merchandise, in identification badges, and within casino chips without a human observer even knowing that the circuit is present, thus providing a secure means of conveying information between the circuit and the interrogator.

However, a radio frequency identification circuit is generally treated as a discrete device in which an interrogator reads information stored within an individual circuit that operates independently from other, perhaps similar circuits. In the event that a user has a need to modify the information output from the radio frequency identification circuit, the user typically must find a way encode new information onto an individual circuit. Alternatively, the user may simply discard the radio frequency identification circuit and obtain a new circuit that includes the new or modified information.

### BRIEF DESCRIPTION OF THE DRAWINGS

FIG. 1 is a block diagram of a resonant and parasitic radio frequency circuit and an associated interrogator according to an embodiment of the invention.

FIG. 2 shows a resonant radio frequency circuit according to an embodiment of the invention.

FIGS. 3A and 3B show two exemplary embodiments of a parasitic radio frequency circuit.

FIG. 4A shows the parasitic radio frequency circuit of FIG. 3A stacked atop the resonant radio frequency circuit of FIG. 2 according to an embodiment of the invention.

FIG. 4B shows the parasitic radio frequency circuit of FIG. 3B stacked atop the resonant radio frequency circuit of FIG. 2 according to an embodiment of the invention.

FIG. 5A shows the features of another resonant radio frequency circuit according to an embodiment of the invention.

FIG. 5B shows the features of a parasitic radio frequency circuit according to a second embodiment of the invention.

FIG. 6 shows a parasitic radio frequency circuit having a switch controlled by an interrogator according to an embodiment of the invention.

FIG. 7A is a side view of three parasitic radio frequency circuits of the type shown in FIG. 6 stacked atop a resonant radio frequency circuit according to an embodiment of the invention.

FIG. 7B shows an equivalent circuit of the parasitic radio frequency circuits of FIG. 7A, according to an embodiment of the invention.

FIG. 8 shows an interrogator having a power coupler according to an embodiment of the invention.

FIG. 9 is a flowchart for a method of conveying information to an interrogator according to an embodiment of the invention.

FIG. 10 is a flowchart for a method of initiating a process based on detecting a resonant radio frequency circuit.

### DESCRIPTION OF THE EMBODIMENTS

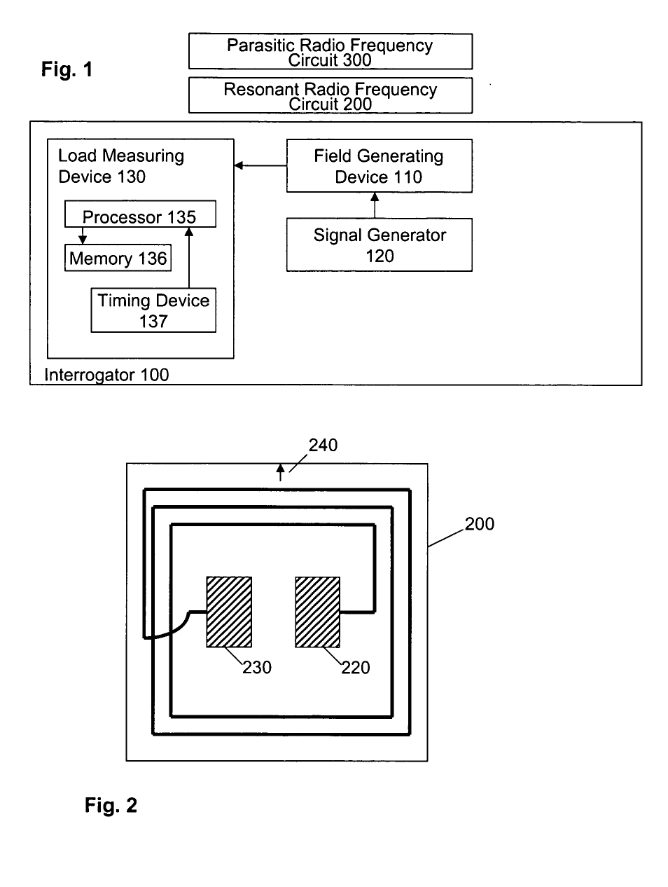

FIG. 1 is a block diagram of a resonant and parasitic radio frequency circuit and an associated interrogator according to an embodiment of the invention. In FIG. 1, interrogator 100 includes signal generator 120, which is capable of generating signals in the range of 10-20 MHz, although in other embodiments of the invention, signals outside of this range may be used. An output of signal generator 120 is coupled to field generating device 110, which generates a magnetic or an electric field that can be coupled to resonant radio frequency circuit 200 and to parasitic radio frequency circuit 300.

In the absence of resonant radio frequency circuit 200 and parasitic radio frequency circuit 300, it is contemplated that only a nominal load is presented to field generating device 110. This nominal load represents the self-inductance and inherent resistance of the field generating device. In the embodiment of FIG. 1, load measuring device 130 operates in conjunction with processor 135 and may calibrate field generating device 110 as a function of frequency as signal generator 120 sweeps the 10-20 MHz frequency range. The various real and reactive load components of field generating device 110, as a function of frequency under nominal conditions, may be stored in memory 136 by processor 135.

When resonant radio frequency circuit 200 is brought within a coupling distance of field generating device 110, load measuring device 130 measures a change in the load presented to the field generating device at the resonant frequency. As it pertains to sensing the presence of a resonant radio frequency circuit, the term “coupling distance” is contemplated as being the distance at which the presence of a resonant radio frequency circuit (such as 200) brings about a detectable change in the load presented to field generating device 110 when the field generating device operates at the resonant frequency. When field generating device 110 operates at frequencies substantially different than the resonant frequency of radio frequency circuit 200, it is contemplated that the circuit presents a nominal load to field generating device 110, even when circuit 200 is within the coupling distance of field generating device 110.

In the embodiment of FIG. 1, bringing resonant radio frequency circuit 200 to within a coupling distance of field generating device 110 causes a change in the load presented to the field generating device at or near the resonant frequency of the resonant radio frequency circuit. In one embodiment of the invention, radio frequency circuit 200 resonates at 13.56 MHz. Thus, as signal generator 120 sweeps from 10-20 MHz, load measuring device 130 measures an increase in the current flow to the field generating device near the 13.56 MHz resonant frequency as energy from the field generating device is coupled to the circuit at or near the resonant frequency. In another embodiment, load measuring device 130 measures a change in the impedance of the field generating device.

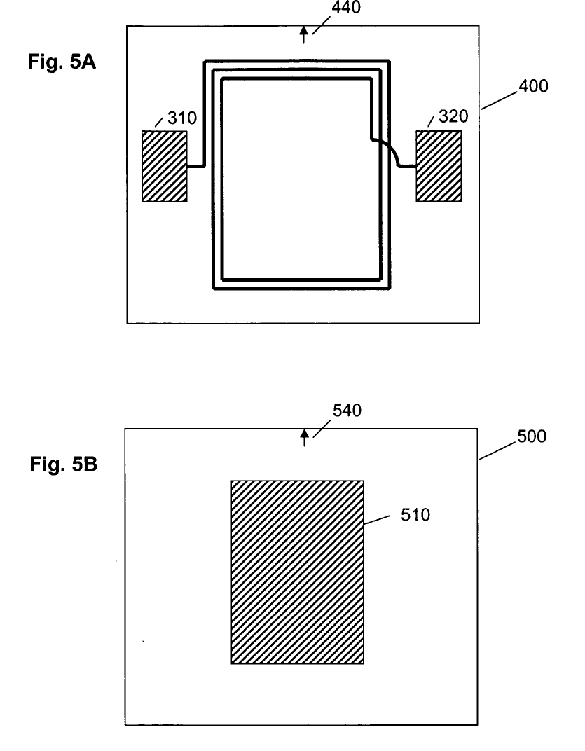

Resonant radio frequency circuit 200 is contemplated as including reactive circuit components, such as a planar spiral inductor, and at least one coplanar capacitor as shown in FIG. 2 and in FIG. 5A. At or near the resonant frequency, energy coupled from field generating device 110 alternates from a magnetic field brought about by currents flowing in the planar spiral inductor, to an electric field brought about by charges distributed on the surface of one or more coplanar capacitors. The resonant frequency of radio frequency circuit 200 can thus be determined by the well-known equation ω₀=(1/LC)^{-1/2}, where “L” equals the value of the planar spiral inductor, and “C” equals the value of the capacitance presented by the coplanar capacitor.

When parasitic radio frequency circuit 300 is brought to within the parasitic coupling distance of resonant radio frequency circuit 200, the presence of parasitic elements on circuit 300 brings about a change the resonant frequency of radio frequency circuit 200. As it pertains to the interaction of parasitic radio frequency circuit 300 with resonant radio frequency circuit 200, the term “parasitic coupling distance” is contemplated as being the distance at which the presence of parasitic radio frequency circuit 300 brings about a change in the resonant frequency of radio frequency circuit 200 as this resonance is sensed by load measuring device 130.

As shown in the example of FIG. 4A, parasitic capacitor elements 310 and 320 couple to corresponding coplanar capacitive elements 230 and 220. The resulting total capacitance of the combination of resonant radio frequency circuit 200 and parasitic radio frequency circuit 300 brings about a shift in the resonant frequency as sensed by load measuring device 130. Timing device 137 can then be used to record a time at which the change in the resonant frequency occurs.

Parasitic radio frequency circuit 300 may make use of any number of reactive circuit components in order to bring about a change in the resonant frequency of the combination of resonant radio frequency circuit 200 and parasitic radio frequency circuit 300. Thus, as has been previously discussed, parasitic radio frequency circuit 300 may include coplanar capacitive elements that couple to corresponding capacitive elements present on resonant radio frequency circuit 200. As a result of the additional capacitance coupled to the resonant radio frequency circuit, the resonant frequency of the combined circuit is shifted to a value lower than the resonant frequency of radio frequency circuit 200.

In another example (FIG. 5B), a parasitic radio frequency circuit (500) includes a ferrite strip (510) having a relative magnetic permeability of greater than 1 to bring about an increase in the value of the inductance present in resonant radio frequency circuit 200. This increase in the inductance brings about a decrease in the resonant frequency of the combination of the resonant (200) and parasitic (300) radio frequency circuits. In another embodiment, a brass strip or other material having a relative magnetic permeability of less than 1 brings about a reduction in the inductance of an inductor present on resonant radio frequency circuit 200. This decrease in the inductance brings about an increase in the resonant frequency of the combination of the resonant (200) and parasitic (300) radio frequency circuits.

In FIG. 2, an exemplary embodiment of a resonant radio frequency circuit 200 is shown. FIG. 2 includes coplanar capacitive elements 220 and 230, which operate in conjunction with planar spiral inductor 210 to provide a resonant circuit. Resonant radio frequency circuit 200 may be printed on a paper, plastic, or other dielectric substrate and then coated with an insulating material that protects the circuit elements from the external environment. Thus, resonant radio frequency circuit 200 can take the form of a hand-held playing card for use in a card game, a casino token, an identification badge, or can be used in any other environment in which the presence of the circuit is identified by way of the value of the resonant frequency or by way of a shift from a first to a second resonant frequency. For example, a resonant frequency of 13.56 MHz may convey an element of information to the interrogator. In a game setting, the resonant frequency of 13.56 MHz may inform the interrogator that the card is a two of clubs, while a second resonant radio frequency circuit having a resonance of 13.76 MHz may represent a three of clubs.

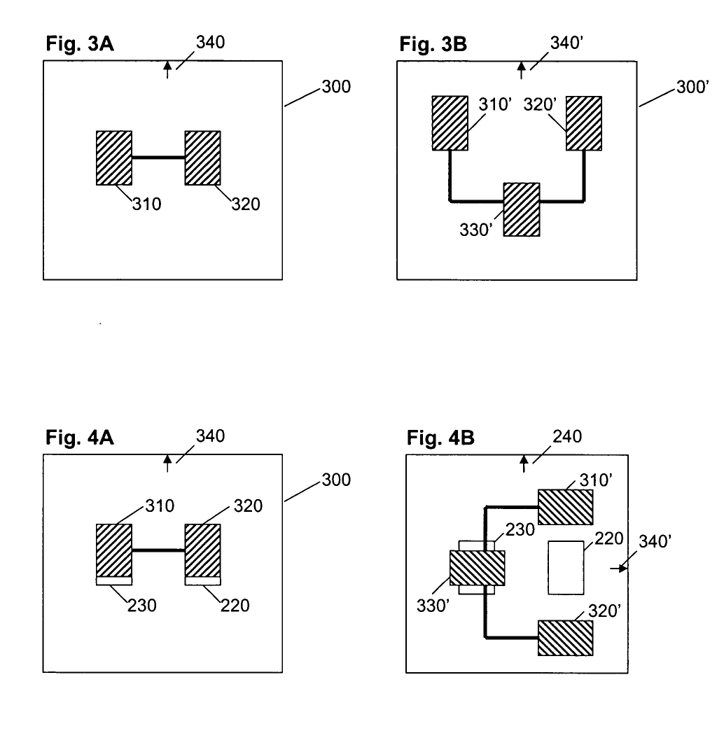

FIGS. 3A and 3B show two exemplary embodiments of a parasitic radio frequency circuit (300, 300′). In FIG. 3A, parasitic radio frequency circuit 300 includes coplanar capacitive elements 310 and 320, along with the conductive trace joining the two capacitive elements, are also printed on a paper, plastic, or other dielectric substrate, and then coated with or encased within an insulator to protect the circuit elements from the external environment. In one embodiment of the invention, the form factor of parasitic radio frequency circuit 300 is similar to that of resonant radio frequency circuit 200. Additionally, the relative locations of parasitic capacitive elements 310 and 320 on the circuit of FIG. 3A correspond to the locations of coplanar capacitive elements 230 and 220 of resonant radio frequency circuit 200. In this embodiment, parasitic radio frequency circuit 300 is substantially flat and designed to be stacked atop other parasitic radio frequency circuits (300) as well as resonant radio frequency circuit (200). Further, as parasitic radio frequency circuits are stacked atop a resonant radio frequency circuit, each shift in the resonant frequency caused by the additional capacitance conveys an element of information to the interrogator.

In an exemplary embodiment, a resonant radio frequency circuit having a resonance of 14.00 MHz conveys to an interrogator that an employee has a level of privilege that permits access to a particular building. When the employee stacks a parasitic radio frequency circuit atop the resonant circuit, bringing about a shift in resonance from 14.00 MHz to 13.75 MHz, this shift may identify to the interrogator that the employee additionally has a level of privilege that allows access to a more secure location within the particular building. In this example, the resonance of 14.00 MHz conveys the information element that the employee has access to the building and unlocks an entrance to the building. At a second interrogator that controls a lock to a secure location within the building, a shift in frequency, from 14.00 to 13.75 MHz for example, conveys the additional information element that the employee also has access to the secure location within the building. Further, the security environment may dictate that the parasitic radio frequency circuit be stacked atop the resonant radio frequency circuit within 5 seconds (for example) as measured by timing device 137. Consequently, if the second interrogator does not measure the change in the resonant frequency within 5 seconds, the entrance remains locked.

In FIG. 3B, similar to the embodiment of FIG. 3A, parasitic capacitive elements 310′, 320′, 330′, and a conductive trace joining the three capacitive elements, are present on parasitic radio frequency circuit 300′. As will be shown in reference to the discussion of FIG. 4, parasitic radio frequency circuit 300′ may be stacked atop resonant radio frequency circuit 200 but oriented differently than underlying circuit 200. Thus, in FIG. 4A for example, a parasitic radio frequency circuit may be oriented such that arrow 340 on circuit 300 aligns with arrow 240 of circuit 200. In another embodiment such as that of FIG. 4B, parasitic radio frequency circuit 300′ may be stacked atop resonant radio frequency circuit 200 such that arrow 340′ points at approximately a 90 degree angle to arrow 240.

As previously suggested, FIG. 4A shows the parasitic radio frequency circuit of FIG. 3A stacked atop the resonant radio frequency circuit of FIG. 2 according to an embodiment of the invention. For reasons of clarity in the illustration, planar spiral inductor 210 and arrow 240 (of FIG. 2) are not shown. As can be seen from FIG. 4A, coplanar capacitive elements 230 and 220 lay beneath parasitic capacitive elements 310 and 320, respectively. Although some portion of coplanar capacitive elements 230 and 220 is shown, nothing prevents parasitic capacitive elements 310 and 320 from completely covering elements 230 and 220.

In another embodiment related to FIG. 4A, parasitic capacitive elements 310 and 320 are printed asymmetrically. Thus, when the orientation of parasitic circuit 300 is changed from face-down to face-up, the parasitic capacitive elements overlay a smaller or larger portion of coplanar capacitive elements 230 and 220. In a game setting, for example, this provides the capability for coupling a different total capacitance by way of turning over a game card that includes one or more parasitic capacitive elements. In this game setting, timing device 137 may be used to record a “winner” or grant a change in the level of privilege based on the player turning the game card over in the shortest amount of time.

FIG. 4B shows the parasitic radio frequency circuit of FIG. 3B stacked atop the resonant radio frequency circuit of FIG. 2 according to an embodiment of the invention. For reasons of clarity in the illustration, planar spiral inductor 210 is not shown. In FIG. 4B, arrow 240 represents the orientation of resonant radio frequency circuit 200. Stacked atop circuit 200 is parasitic radio frequency circuit 300′, in which the parasitic circuit is oriented at a 90 degree angle to the underlying resonant radio frequency circuit (200) as shown by arrow 340′ on circuit 300′. Thus, in this example, parasitic capacitive element 330′ lies directly over coplanar capacitive element 230, with parasitic capacitive elements 310′ and 320′ being largely uncoupled from coplanar capacitive element 220.

Therefore, it can be seen that when parasitic radio frequency circuit 300′ is aligned in the same direction as resonant radio frequency circuit 200, a first change in the total capacitance, and a first corresponding resonant frequency shifts results. When the alignment of resonant radio frequency circuit 200 and parasitic radio frequency circuit 300 differ by 90 degrees, a second change in total capacitance, and a second corresponding resonant frequency shift results. This allows the information conveyed to an interrogator, by way of the interrogator sensing the resonant frequency shift, to be dependent on the relative orientation of the resonant and parasitic circuit. Further, although FIGS. 4A and 4B illustrate only a single change in the orientation of the parasitic radio frequency circuit, parasitic radio frequency circuits can be designed such that any change in the orientation, including angles less than 90 degrees, multiples of 90 degrees, or other angles can bring about a detectible change in the total capacitance of the resonant and parasitic circuit. Thus, in another embodiment, additional capacitive elements similar to 310′, 320′, and 330′ can be arranged at other locations on parasitic radio frequency circuit 300′ so that stacking circuit 300′ atop circuit 200 with arrow 340′ pointing at a 45 degree angle (or any other acute or obtuse angle) to arrow 240 results in another value of total capacitance presented to the underlying resonant circuit.

FIG. 5A shows the features of another resonant radio frequency circuit according to an embodiment of the invention. In FIG. 5A, planar spiral inductor 410 is shown near the center while coplanar capacitive elements 420 and 430 are located to the left and to the right of inductor 410. In the embodiment of FIG. 5A, the inductive and capacitive circuit elements are printed on a paper, plastic, or other dielectric substrate. Similar to resonant radio frequency circuit 200, resonant radio frequency circuit 400 can be formed into a hand-held playing card for use in a game, a casino token, an identification badge, and so forth.

FIG. 5B shows the features of another parasitic radio frequency circuit according to an embodiment of the invention. In FIG. 5, parasitic radio frequency circuit 500 includes ferrite strip 510 having a relative magnetic permeability of greater that 1. Parasitic radio frequency circuit 500 can be stacked atop resonant radio frequency circuit 400 such that ferrite strip 510 overlays the center region surrounded by planar spiral inductor 410. When ferrite strip 510 is overlaid atop resonant radio frequency circuit 400, such that arrows 540 and 440 are aligned, the ferrite strip brings about an increase in the total value of the inductance of the combination of the resonant and parasitic radio frequency circuit. This, in turn, shifts the resonant frequency, as sensed by an interrogator, to a lower value.

As previously mentioned herein, ferrite strip 510 can be replaced by a material such as brass having a relative magnetic permeability of less than 1. In this example, a parasitic radio frequency circuit overlaid on resonant radio frequency circuit 400 brings about a reduction in the total value of the inductance in the combination of the resonant and parasitic radio frequency circuit. This, in turn, shifts the resonant frequency to a higher value.

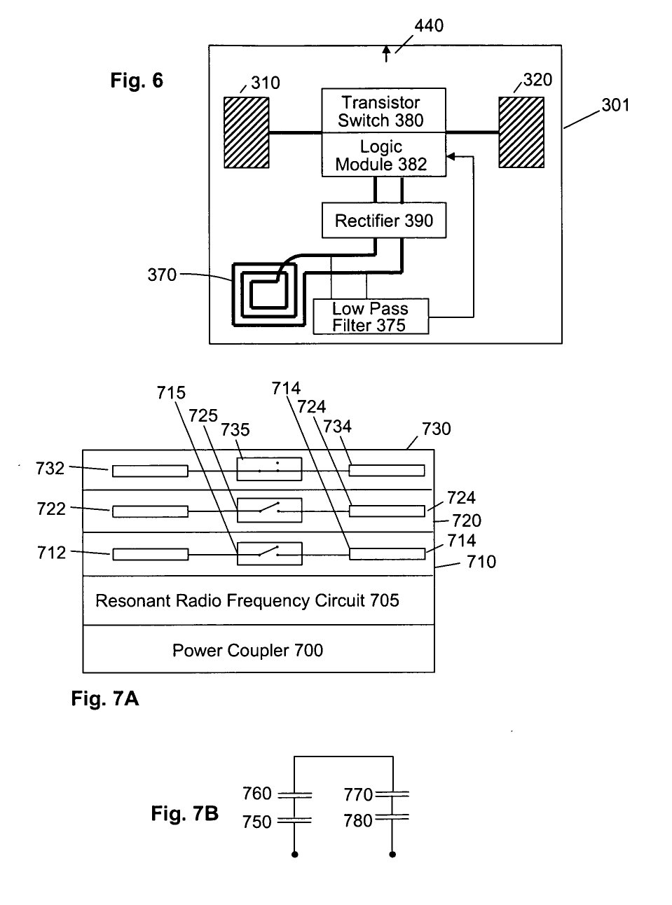

FIG. 6 shows parasitic radio frequency circuit 301 having reactive elements that can be controlled by an interrogator according to an embodiment of the invention. In FIG. 6, transistor switch 380 is placed between capacitive elements 310 and 320. Transistor switch 380 is contemplated as being a solid-state transistor switch that either electrically connects or electrically isolates parasitic capacitive elements 310 and 320 from each other. To bring about this switching, a suitable magnetic field (which may be separate from the field generated by field generating device 110) conveys electrical power to inductor 370. In this example, signaling information in the form of a unique bit pattern is imposed on the magnetic field that couples to inductor 370. Thus, signaling information is conveyed by way of the magnetic field being switched on and off according to the particular bit pattern. Low pass filter 375 strips off the signaling information and passes the bit pattern to logic module 382 of transistor switch 380. The unfiltered, raw power signal from inductor 370 is conveyed to rectifier 390 so that primary power can be provided to transistor switch 380 and logic module 382.

The architecture of FIG. 6 allows a magnetic field to be modulated with a particular bit pattern so that the capacitance value of a parasitic radio frequency circuit can be controlled. Thus, as shown in FIG. 7A, more than one parasitic radio frequency circuit of FIG. 6 can be stacked atop a resonant radio frequency circuit. In FIG. 7A, parasitic radio frequency circuits 710, 720, and 730 are stacked atop resonant radio frequency circuit 705. Parasitic radio frequency circuit 710 includes coplanar capacitive elements 712 and 714, which can be electrically connected or isolated from each other by way of transistor switch 715. In a similar manner, parasitic radio frequency circuit 720 includes coplanar capacitive elements 722 and 724, which can be electrically connected or isolated from each other by way of transistor switch 725. In a similar manner, parasitic radio frequency circuit 730 includes coplanar capacitive elements 732 and 734, which can be electrically connected or isolated from each other by way of transistor switch 735.

Each of transistor switches 715, 725, and 735 is coupled to a logic module similar to logic module 382 of FIG. 6. Additionally, each of the parasitic radio frequency circuits shown in FIG. 7A includes an inductor (similar to inductor 370 of FIG. 6), as well as a low pass filter (similar to low pass filter 375) and a rectifier (similar to rectifier 390). This allows power coupler 700 to provide a modulated power signal to each of parasitic radio frequency circuits 710, 720, and 730 so that each of switches 715, 725, and 735 can be individually controlled. In FIG. 7A, transistor switches 715 and 725 are in the open state, while transistor switch 735 is in a closed state.

FIG. 7B shows an equivalent circuit of the parasitic radio frequency circuit of FIG. 7A according to an embodiment of the invention. In FIG. 7B, capacitor 750 is formed by capacitive elements 712 and 722. Capacitor 760 is formed by capacitive elements 722 and 732. Capacitor 770 is formed by capacitive elements 734 and 724. And, capacitor 780 is formed by capacitive elements 724 and 714. Thus, as switches 715, 725, and 735, are opened and closed, the value of the capacitance coupled to resonant radio frequency circuit 705 can be controlled. And, the equivalent circuit shown in FIG. 7B can be used to model the parasitic capacitance resulting from the switching.

From the equivalent circuit of FIG. 7B, it can be seen that in the event that parasitic radio frequency circuits 710, 720, and 730 are rearranged, a different total capacitance (and thus a different resonant frequency) can result. For example, if switch 735 remains closed and parasitic radio frequency circuit 730 is inserted between resonant circuit 705 and parasitic circuit 710, the capacitances presented by parasitic circuits 710 and 720 do not contribute to the total capacitance of the combination of the parasitic and the resonant circuits, since circuits 710 and 720 are above the short circuit caused by closing switch 735. Thus, it can be seen that the stacking order of parasitic circuits 710, 720, and 730 atop resonant radio frequency circuit 705 can affect the total capacitance of the combined circuit.

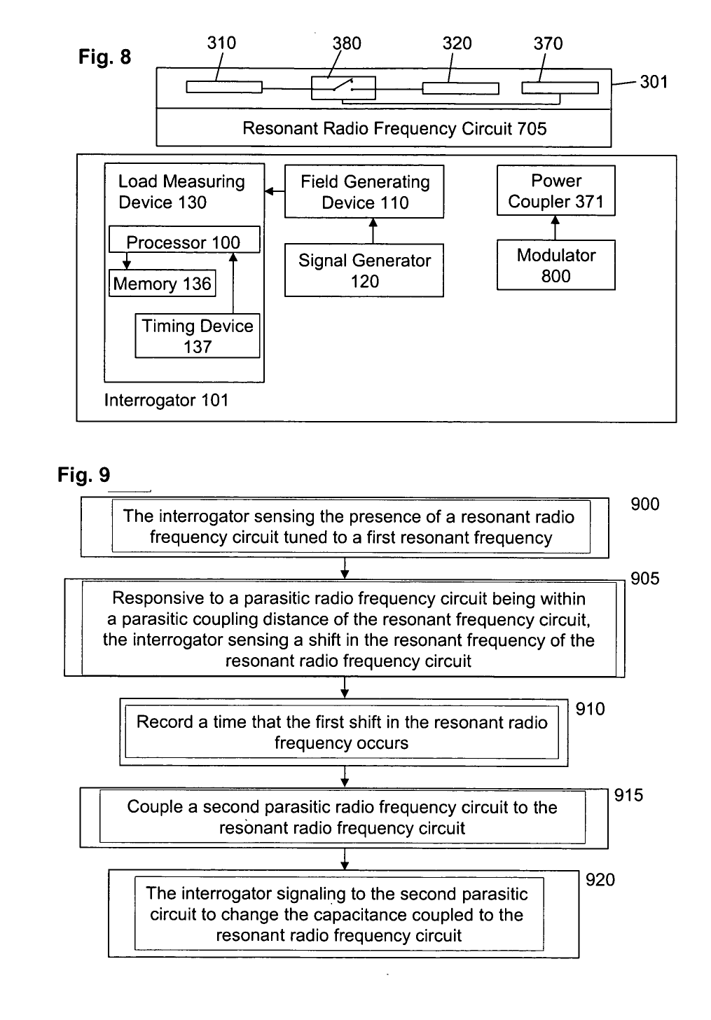

FIG. 8 shows an interrogator having a power coupler according to an embodiment of the invention. In FIG. 8, interrogator 101 includes measuring device 130, field generating device 110, signal generator 120 and so forth. FIG. 8 also includes power coupler 371 and modulator 800 that function to generate a modulated power signal that couples to inductor 370 to signal or otherwise control switch 380 to open or close the connection between parasitic capacitive elements 310 and 320. (Rectifier 390, logic module 382, and low pass filter 375 are not shown for reasons of maintaining clarity in the drawing.)

FIG. 9 is a flowchart for a method of conveying information to an interrogator according to an embodiment of the invention. The system of FIG. 8 is suitable for performing the method of FIG. 9. The method of FIG. 9 begins at step 900, in which an interrogator senses the presence of a resonant radio frequency circuit that is tuned to a first resonant frequency. At step 905, responsive to a parasitic radio frequency circuit being brought to within a parasitic coupling distance of the resonant radio frequency circuit, the interrogator senses a shift in the resonant frequency of the resonant radio frequency circuit, thus conveying an element of information to the interrogator. Step 905 may be performed by stacking a parasitic capacitance atop the resonant radio frequency circuit, or may be performed by stacking a material that affects the inductance of the resonant radio frequency circuit.

The method continues at step 910 in which a time is recorded that corresponds to the time that the first shift in the resonant frequency occurred. This may be useful in a game environment, for example, where players must perform certain actions within a specified time period. At step 915 a second parasitic radio frequency circuit is coupled to the resonant radio frequency circuit. This step may also be useful in game environment where handheld game cards or tokens that contain parasitic and resonant circuits are stacked atop other cards according the game's rules. In this example, the presence of additional parasitic circuits (and the attendant resonant frequency shifts that result from stacking the additional parasitic circuits) may bring about a change in the level of privilege of one or more players. In other environments, the interrogator detecting the presence of one or more parasitic circuits (by way of the detection of a shift in resonance) causes the interrogator to initiate other processes, such as unlocking a door. The method concludes at step 920 in which the interrogator signals to the parasitic radio frequency circuit to change the capacitance coupled to the resonant radio frequency circuit.

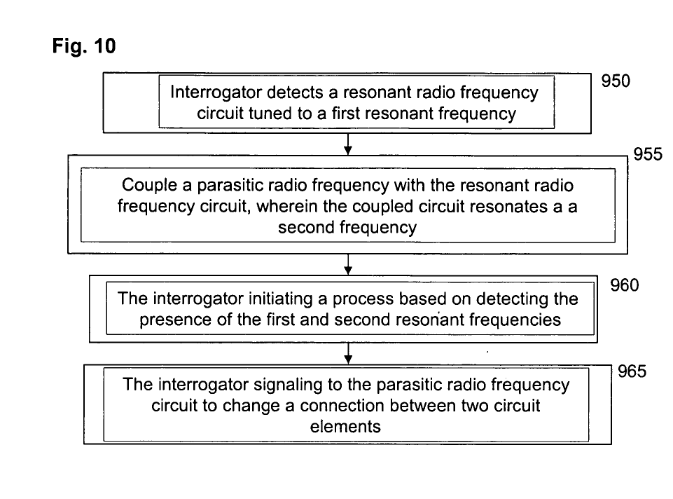

FIG. 10 is a flowchart for a method of initiating a process based on detecting a resonant radio frequency circuit. The apparatus of FIG. 8 is suitable for performing the method of FIG. 10. The method begins at step 950 in which an interrogator detects a resonant radio frequency circuit that is tuned to a first resonant frequency. The method continues at step 955 in which a parasitic radio frequency circuit is coupled with the resonant radio frequency circuit, thus causing the coupled circuit to resonate at a second frequency. At step 960, the interrogator initiates a process based on detecting the presence of the first and second resonant frequencies. In one embodiment, the process initiated by the interrogator can include opening a lock used to control the physical access to a facility. In another embodiment, the process initiated by the interrogator may include initiating an electronic or computer process as part of a game.

The method continues at step 965 in which the interrogator signals to the parasitic radio frequency circuit to change a connection between circuit elements present within the parasitic radio frequency circuit. As discussed relative to FIGS. 6, 7A and 7B, this change in the connection between circuit elements brings about a change in the total capacitance of the combination of the resonant and parasitic radio frequency circuit. Also as discussed in these Figures, a parasitic radio frequency circuit having capacitive elements that have been electrically connected, such as by way of switch 380 of FIG. 6, may be rearranged in a stack of similar parasitic circuits. As this rearrangement affects the total capacitance of the combination of resonant and parasitic circuits, the rearrangement can be detected by the interrogator.

In conclusion, while the present invention has been particularly shown and described with reference to the foregoing preferred and alternative embodiments, those skilled in the art will understand that many variations may be made therein without departing from the spirit and scope of the invention as defined in the following claims. This description of the invention should be understood to include the novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring nor excluding two or more such elements.

What is claimed is:

1. A method of conveying information to an interrogator, comprising:
the interrogator sensing the presence of a resonant radio frequency circuit that is tuned to a first resonant frequency; and
responsive to a parasitic radio frequency circuit being brought to within a parasitic coupling distance of the resonant radio frequency circuit, the interrogator sensing a shift in the resonant frequency of the resonant radio frequency circuit, wherein the first shift in the resonant frequency conveys a first information element to the interrogator.

2. The method of claim 1, wherein the resonant radio frequency circuit is printed on one of the group consisting of a hand-held playing card, a casino token, and an identification badge.

3. The method of claim 2, wherein the parasitic radio frequency circuit is printed on is printed on one of the group consisting of a hand-held playing card, a casino token, and an identification badge, thereby allowing the second token to be stacked atop the resonant radio frequency circuit.

4. The method of claim 1, wherein the parasitic radio frequency circuit operates by coupling a capacitance to the resonant radio frequency circuit.

5. The method of claim 5, further comprising the interrogator signaling to the parasitic radio frequency circuit to change the capacitance coupled to the resonant radio frequency circuit.

6. The method of claim 1, wherein the parasitic radio frequency circuit operates by changing an inductance of the resonant radio frequency circuit.

7. The method of claim 1, further comprising coupling a second parasitic radio frequency circuit to the resonant radio frequency circuit, thereby causing at least one additional shift in the resonant frequency.

8. The method of claim 1, wherein the parasitic radio frequency circuit is disposed on a handheld token, and wherein the method additionally comprises changing the orientation of the handheld token to convey a second amount of information to the interrogator.

9. The method of claim 8, wherein the changing step further comprises turning over the handheld token.

10. The method of claim 8, wherein the changing step comprises orienting the handheld token by a multiple of approximately 90 degrees relative to the orientation of the resonant radio frequency circuit.

11. The method of claim 8, wherein the changing step comprises orienting the handheld token by an acute angle relative to the orientation of the resonant radio frequency circuit.

12. The method of claim 1, wherein the interrogator also records timing information that pertains to a time that the first shift in the resonant frequency occurs.

13. The method of claim 12, wherein the time that the first shift in the resonant frequency occurs influences a level of privilege of a player according the rules of a game program that runs on a processor that controls the operation of the interrogator.

14. An interrogator comprising:
a field generating device for coupling to a resonant radio frequency circuit;
a signal generator coupled to the field generating device; and
a measuring device for determining that the signal generator has tuned the field generating device to the resonant frequency of the resonant radio frequency circuit, wherein
the measuring device additionally determines that the resonant frequency of the resonant radio frequency circuit has changed from a first to a second frequency.

15. The interrogator of claim 14, wherein the change from the first to the second resonant frequency conveys information to the interrogator.

16. The interrogator of claim 14, wherein a change from the second to a third resonant frequency conveys information to the interrogator.

17. The interrogator of claim 14, wherein a time at which the resonant radio frequency circuit changes from the first to the second resonant frequency conveys information to the interrogator.

18. The interrogator of claim 14, further comprising a modulator that signals a switch located on a parasitic token located within a coupling distance of the interrogator.

19. The interrogator of claim 14, wherein the measuring device includes a load measuring circuit that measures resonance by measuring changes in the current coupled into the field generating device.

20. The interrogator of claim 14, wherein the measuring device includes a load measuring circuit that measures resonance by measuring changes in the impedance of the field generating device.

21. The interrogator of claim 14, wherein the field generating device generates a magnetic field.

22. A method comprising:
an interrogator detecting a resonant radio frequency circuit that is tuned to a first resonant frequency;
a user coupling a parasitic radio frequency circuit with the first resonant radio frequency circuit to form a coupled circuit, the coupled circuit resonating at a second frequency; and
the interrogator initiating a process based on detecting the presence of the first and the second resonant frequency.

23. The method of claim 22, wherein the process initiated comprises opening a lock.

24. The method of claim 22, wherein the presence of the resonant radio frequency circuit conveys a first level of privilege to the user, and wherein the detection of the second resonant frequency conveys a second level of privilege to the user.

25. The method of claim 24, wherein the first and second levels of privilege pertain to granting the user access to a facility.

26. The method of claim 24, wherein the first and second levels of privilege are conveyed to the user during an electronic game.

27. The method of claim 22, wherein the resonant and parasitic radio frequency circuits are each disposed within a corresponding resonant and parasitic handheld card, and wherein changing the orientation of the parasitic handheld card relative to the resonant handheld card causes the interrogator to initiate a second process.

28. The method claim 27, wherein the changing step includes rotating the parasitic handheld card at a right angle to the direction of the resonant card.

29. The method of claim 22, wherein the interrogator signals to the parasitic radio frequency circuit to change a connection between a plurality of reactive circuit elements present within the parasitic radio frequency circuit.

30. The method of claim 29, wherein the plurality of reactive circuit elements are capacitors.

31. The method of claim 29, additionally comprising the interrogator sensing that the parasitic radio frequency circuit has been reordered among other parasitic radio frequency circuits in a stack.

32. A system, comprising:
an interrogator;
at least one handheld card that includes a resonant radio frequency circuit;
at least one handheld card that includes a parasitic radio frequency circuit;
wherein the interrogator causes a first process to occur in response to detecting the presence of the resonant radio frequency circuit, and
wherein the interrogator causes a second process to occur in response to detecting that the parasitic radio frequency circuit is within a coupling range of the resonant radio frequency circuit.

33. The system of claim 32, wherein the interrogator includes a signaling unit to signal a parasitic radio frequency circuit to change a connection between at least two reactive circuit elements present in the parasitic radio frequency circuit.

34. A system, comprising:
means for detecting the presence of a resonant radio frequency circuit; and
means for detecting that a parasitic radio frequency circuit is within a parasitic coupling range of the resonant radio frequency circuit.

35. The system of claim 34, wherein the means for detecting the presence of the resonant radio frequency circuit includes means for generating one of an electric and a magnetic field that couples to the resonant radio frequency circuit.

36. The system of claim 34, further comprising means for initiating a process resulting from detecting the presence of the resonant and parasitic radio frequency circuits.

37. The system of claim 36, wherein the process is permitting a user to enter a facility.

38. The system of claim 36, wherein the process is assigning a level of privilege to a user interacting with an electronic game.

39. The system of claim 34, wherein the parasitic radio frequency circuit includes a means for forming a connection between a plurality of reactive elements present on the parasitic radio frequency circuit, and wherein the system further comprises means for controlling the connection between the plurality of reactive elements.

40. A parasitic radio frequency circuit, comprising:
an inductor that receives a modulated power signal from a magnetic field;
a low pass filter that removes signaling information from the modulated power signal; and
a switch that controls the connection between at least two reactive elements based on the signaling information.

41. The parasitic radio frequency circuit of claim 40, wherein the reactive elements are coplanar capacitive elements.
